(19) United States
(12) Patent Application Publication
(10) Pub. No.: US 2007/0006904 A1
(43) Pub. Date: Jan. 11, 2007

(54) Substrate cleaning system and substrate cleaning method

(75) Inventors: Takehiro Hagiwara, Tokyo (JP); Tatsuo Kataoka, Tokyo (JP); Seiji Noda, Tokyo (JP); Takafumi Nakai, Tokyo (JP)

Correspondence Address: BIRCH STEWART KOLASCH & BIRCH, PO BOX 747, FALLS CHURCH, VA, 22040-0747, US

(73) Assignee: SPC ELECTRONICS CORPORATION, Tokyo (JP)

(21) Appl. No.: 11/474,486

(22) Filed: Jun. 26, 2006

(30) Foreign Application Priority Data
Jun. 27, 2005 (JP) 2005-185941
May 24, 2006 (JP) 2006-144690

(51) Int. Cl. B08B 3/00; B08B 3/12

(52) U.S. Cl. 134/198; 134/94.1; 134/103.2; 134/34; 134/26

(57) ABSTRACT

A substrate cleaning system that cleans a glass substrate by supplying liquid and gas to spray nozzles and by spraying fluid, where the liquid and the gas are mixed in the spray nozzles, onto the substrate in order to effectively remove foreign objects attached on the end surface of substrate after performing mechanical cut-off or polishing treatment, the system has: liquid heating means for heating the liquid to be supplied to the spray nozzles to control the temperature of the liquid, in which the temperature of the liquid at the inlet of the spray nozzles is controlled at 40° C. to 100° C.

### BACKGROUND OF THE INVENTION

1. Field of The Invention

The present invention relates to a substrate cleaning system and a substrate cleaning method, particularly to a substrate cleaning system and a substrate cleaning method, in which cleaning treatment is applied by supplying cleaning liquid to various types of substrate such as a glass substrate of a liquid crystal display device, a glass substrate for a photo mask and a substrate for an optical disk (in this specification, various types of substrate such as a glass substrate of a liquid crystal display device, a glass substrate for a photo mask and a substrate for an optical disk are collectively referred to simply as a “substrate”).

2. Description of The Related Art

As a conventional cleaning system of substrate, a cleaning system is known, in which a plurality of spray nozzles are arranged along the peripheral area of a semiconductor wafer with an equal gap and water droplet flow having the flow speed of 250 m/s or more is blown from the plurality of spray nozzles to the peripheral area to clean the substrate, for example (refer to Patent document 1, for example).

Herein, to spray the water droplet flow having the flow speed of 250 m/s or more, the above-described cleaning system is provided with a supply source that supplies cleaning water and gas in a mixed state to the spray nozzles with high pressure.

Then, by spraying the ultra high-speed water droplet flow having the flow speed of 250 m/s or more to the peripheral area of the substrate by such action of the supply source, polishing waste attached to the peripheral area of the substrate, which cannot be removed only by immersing the wafer in cleaning liquid, can be removed without damaging the semiconductor wafer by the collision of the ultra high-speed water droplet flow.

However, in the case of cleaning the end surface of substrate after performing mechanical cut-off or polishing treatment in a manufacturing process of glass substrate or the like, for example, there was a problem that the spray nozzles of the above-described conventional cleaning system could not sufficiently remove foreign objects attached to the end surface of substrate.

Patent document 1: Japanese Patent Laid-open No. 2003-7668 publication

### OBJECTS AND SUMMARY OF THE INVENTION

The present invention has been created in view of the above-described problems that the prior art has, and it is an object of the invention to provide a substrate cleaning system and a substrate cleaning method, which are capable of effectively removing foreign objects attached to the end surface or the like of a substrate after performing mechanical cut-off or polishing treatment.

To achieve the object, the substrate cleaning system and the substrate cleaning method according to the present invention are that liquid heating means adjusts the temperature of liquid flowing into the spray nozzles and the liquid whose temperature was adjusted is mixed with gas and sprayed onto the substrate. Gas described in this specification denotes air or inert gas such as argon and nitrogen in a strict sense.

Further, the substrate cleaning system and the substrate cleaning method according to the present invention are that vapor and liquid that consists of the same component as the vapor are mixed and sprayed onto the substrate. Vapor described in this specification denotes steam that consists of any of water, pure water and ultra pure water.

Therefore, according to the present invention, by spraying fluid, in which the liquid whose temperature was adjusted as described above is mixed with gas, or vapor and the liquid onto a substrate that is the end surface of the substrate after performing mechanical cut-off or polishing treatment, for example, it becomes possible to effectively clean the end surface or the like of the substrate after performing mechanical cut-off or polishing treatment.

[Detail Description of Claims]

Specifically, the present invention is the substrate cleaning system that cleans a glass substrate by supplying liquid and gas to spray nozzles and by spraying fluid, where the liquid and the gas are mixed in the spray nozzles, onto the end surface of the substrate, in which the system has liquid heating means for heating the liquid to be supplied to the spray nozzles to control the temperature of the liquid, in which the temperature of the liquid at the inlet of the spray nozzles is controlled at 40° C. to 100° C.

Further, the present invention is that the liquid heating means is disposed in an area of a route introducing the liquid to the spray nozzles, which is near the spray nozzles.

Further, the present invention is the substrate cleaning system that cleans a substrate by fluid sprayed from spray nozzles, where the system has spray nozzles disposed near the substrate and vapor generating means for generating vapor and supplying the vapor to the spray nozzles, in which the spray nozzles spray the vapor supplied from the vapor generating means and liquid, which consists of the same component as the vapor, onto the substrate after mixing the vapor and the liquid.

Further, the present invention is that the shape of spray port of the spray nozzles is in a linear shape.

Furthermore, the present invention is that mixed flow sprayed from the spray nozzles is mixed flow of the vapor of liquid having the boiling point of 40° C. or higher, and liquid that consists of the same component as the vapor.

Further, the present invention is a substrate cleaning method that cleans a substrate by supplying liquid and gas to spray nozzles and by spraying fluid, where the liquid and the gas are mixed in the spray nozzles, onto the substrate, in which the liquid to be supplied to the spray nozzles is heated and the temperature of the liquid is controlled to 40° C. to 100° C.

Further, the present invention is a substrate cleaning method that cleans a substrate by fluid sprayed from spray nozzles, in which vapor and liquid, which consists of the same component as the vapor, are supplied to the spray nozzles, and the mixed flow of the vapor supplied from the spray nozzles and the liquid, which consists of the same component as the vapor, is sprayed onto the substrate.

Furthermore, the present invention is that the vapor sprayed from the spray nozzles is steam that consists of any of water, pure water and ultra pure water.

Still further, the present invention is that the temperature of the end surface of a substrate is increased to 40° C. to 100° C. by the fluid sprayed from the spray nozzles.

The present invention exerts an excellent effect as described above that it can spray liquid droplets whose temperature is adjusted to 40° C. to 100° C., can lift off foreign objects, which are attached to the end surface of the substrate after performing mechanical cut-off or polishing treatment, from the end surface, and can blow off the objects from the end surface by instantaneously giving high kinetic energy caused by jet flow.

The present invention can be used in cleaning various types of substrate such as a glass substrate of a liquid crystal display device, a glass substrate for a photo mask and a substrate for an optical disk.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic constitution explanatory view of a substrate cleaning system according to a first embodiment of the present invention;

FIG. 2 is a graph showing a result of experiment which was conducted by using the substrate cleaning system according to the first embodiment of the present invention;

FIG. 3 is a schematic constitution explanatory view of a substrate cleaning system according to a second embodiment of the present invention;

FIG. 4 is a graph showing a result of experiment which was conducted by using the substrate cleaning system according to the second embodiment of the present invention;

FIG. 5 is a schematic constitution explanatory view of a substrate cleaning system according to a third embodiment of the present invention;

FIG. 6 is a graph showing a result of experiment which was conducted by using the substrate cleaning system according to the first embodiment of the present invention;

FIG. 7 is a graph showing a result of experiment which was conducted by using the substrate cleaning system according to the first embodiment of the present invention;

FIG. 8 is a schematic explanatory view explaining the effect of the present invention;

FIG. 9 is a graph showing a result of experiment which was conducted by using the substrate cleaning system according to the first embodiment of the present invention;

FIG. 10(a) is a conceptual perspective explanatory view showing the shape of a spray port of a spray nozzle, and FIG. 10(b) is a conceptual perspective explanatory view showing the state where vapor is sprayed from the spray port;

FIG. 11 is an explanatory view showing a modified example of the substrate cleaning system according to the present invention; and

FIG. 12 is another explanatory view showing a modified example of the substrate cleaning system according to the present invention.

### DETAILED DESCRIPTION OF THE PREFERRED EMBODIMENTS

In the following, description will be made for an embodiment example of the substrate cleaning system and the substrate cleaning method according to the present invention based on the attached drawings.

Unevenness of the end surface of a semiconductor wafer is as relatively flat as 1 μm to 10 μm and most foreign objects attached on the surface is 1 μm or less. On the other hand, unevenness of about 0.1 μm to 500 μm exists on the end surface of a glass substrate and foreign objects of about 1 μm to 100 μm caused by glass or polishing agent are attached on the inside and the surface of the unevenness, and it was difficult to remove them.

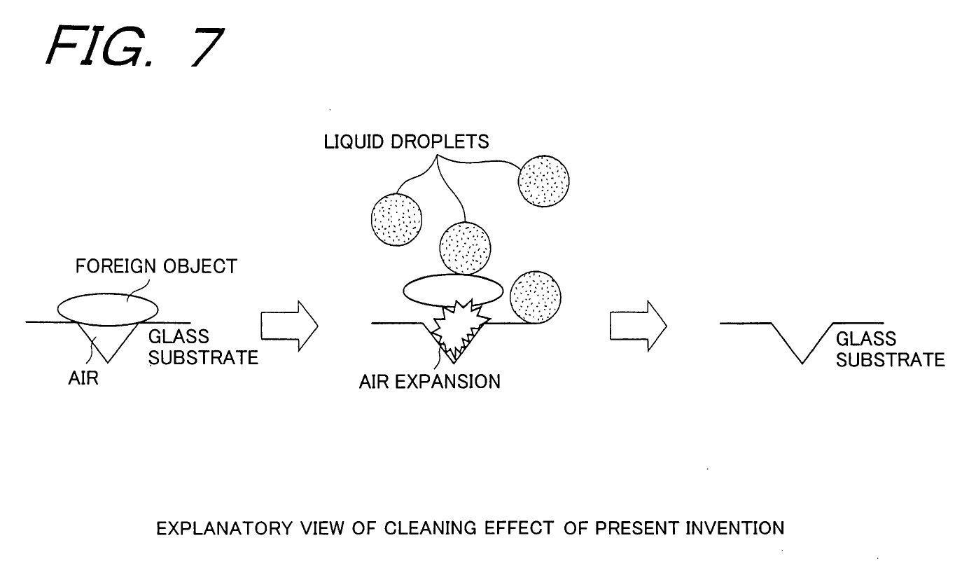

The inventor believes that the reason why high cleaning effect is obtained by a substrate cleaning system 10 according to the present invention is caused by the fact that a space between foreign objects having the size of 1 μm to 100 μm and the end surface 14b of a glass substrate 14 is large as shown in FIG. 7 and by the lift-off of the foreign objects from the end surface 14b of glass substrate caused by volume expansion of air inside the space. Comparing to foreign objects of 1 μm or less, a larger volume space exists between the foreign objects having the size of 1 μm to 100 μm and the end surface 14b of glass substrate having the unevenness of about 0.1 μm to 500 μm, and it is believed that the large space promoted the lift-off effect. Generally, the volume expansion coefficient of air is 3.7×10⁻³K⁻¹ showing a value larger than that of solid by 2 digits or more, so that the promotion of lift-off effect by the increase of the space volume is remarkable.

Therefore, the high cleaning effect that is obtained by the substrate cleaning system 10 according to the present invention is synergy effect obtained by instantaneously generating both the kinetic energy given by liquid droplets and the volume expansion of air that exists between the foreign object and the end surface 14b of the glass substrate 14 by the mixed flow of liquid and gas, which is ejected from spray nozzles 18, and it is a new method of removing foreign objects.

### EXAMPLE 1

(Basic Constitution)

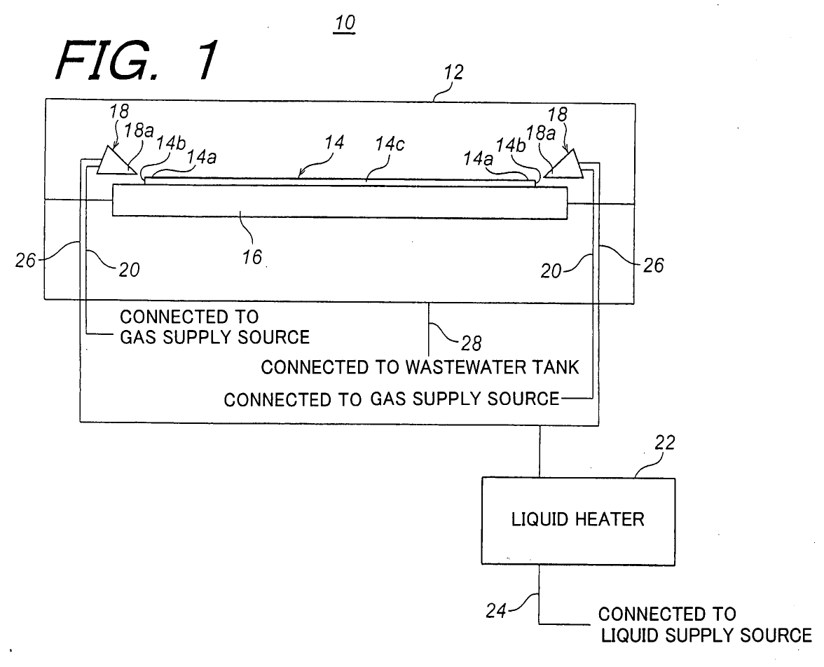

FIG. 1 shows the schematic constitution explanatory view of the substrate cleaning system according to the first embodiment of the present invention. It is to be noted that a glass substrate as the substrate should be cleaned in the substrate cleaning system according to the first embodiment of the present invention.

The substrate cleaning system 10 shown in FIG. 1 includes a case 12, and a roller conveyer 16 that horizontally mounts the glass substrate 14 thereon and transports the glass substrate 14 in vertical directions to the page surface of FIG. 1 is disposed in the case 12.

Further, a spray nozzle 18, whose spray port 18a is arranged toward the end surface 14b of the glass substrate 14, is disposed near each peripheral area 14a of the glass substrate 14 in the case 12.

Then, a gas supply pipe 20 connected to an external gas supply source (not shown) such as a gas tank is connected to the spray nozzles 18, and gas is supplied to the spray nozzles 18 from the gas supply source via the gas supply pipe 20.

Further, a liquid heater 22 for heating liquid is disposed to the substrate cleaning system 10. Then, a first liquid supply pipe 24 connected to an external liquid supply source (not shown) such as a liquid tank is connected to the liquid heater 22, and liquid is supplied to the liquid heater 22 from the liquid supply source via the first liquid supply pipe 24. The liquid heater 22 heats the liquid supplied from the liquid supply source via the first liquid supply pipe 24.

Furthermore, a second liquid supply pipe 26 is disposed between the spray nozzles 18 and the liquid heater 22, and the heated liquid is supplied from the liquid heater 22 to the spray nozzles 18 via the second liquid supply pipe 26.

Further, a drain port (not shown) is provided for the bottom surface of the case 12, a drain pipe 28 connected to a wastewater tank (not shown) is attached to the drain port, and drainage is sent from the drain port to the wastewater tank via the drain pipe 28. (Detail description of constitution)

Next, each of the above-described constitutions is described in detail. First, the liquid heater 22 includes a liquid storage tank that stores liquid supplied from the liquid supply source, a water level sensor for measuring the water level of the liquid stored in the liquid storage tank, a heater that heats the liquid stored in the liquid storage tank, a liquid temperature sensor that measures the temperature of the liquid heated by the heater, an electric power control mechanism that controls electric power to be supplied to the heater in order to control the heating temperature of the liquid to be heated by the heater, a liquid supply pump for supplying the liquid heated by the heater to the spray nozzles 18 via the second supply pipe 26, a discharge port of wastewater, and the like.

Further, the spray nozzle 18 includes an inflow port of high-pressure gas held at 1 kgf/cm² to 10 kgf/cm², which is supplied via the gas supply pipe 20, includes an inflow port of liquid held at 1 kgf/cm² to 10 kgf/cm², which is supplied via the second liquid supply pipe 26, and includes a structure where the high-pressure gas and the liquid are mixed in a piping having the inner diameter of 0.1 mm to 50 mm and the mixed flow of the gas and the liquid is discharged from one piping having the inner diameter of 0.1 mm to 50 mm, which is communicated with the spray port 18a.

It is to be noted that pure water or ultra pure water, for example, can be used as liquid supplied to the spray nozzles 18.

Furthermore, as liquid supplied to the spray nozzles 18, liquid containing at least one component out of hydrofluoric acid, phosphoric acid, acetic acid, oxalic acid, ammonium fluoride, potassium fluoride, sodium fluoride, calcium fluoride and triethyl phosphate, for example, may be used instead of pure water or ultra pure water.

In other words, pure water or ultra pure water may be used as the liquid supplied to the spray nozzles 18 when adhesion between the foreign object and the glass substrate 14 is relatively small. However, when the foreign object and the glass substrate 14 are firmly adhered (for example, the case where foreign objects and the glass substrate 14 are closely adhered via solid other than the foreign objects and the glass substrate 14), it is preferable to use fluid in which the above-described substance such as hydrofluoric acid, phosphoric acid, acetic acid, oxalic acid, ammonium fluoride, potassium fluoride, sodium fluoride, calcium fluoride and triethyl phosphate, which generates fluoride ion, phosphate ion or organic calboxylic acid ion, is added to pure water or ultra pure water in the range of 0.01% to 50%. Further, it is also preferable to use fluid in which a substance such as tetramethylammonium hydroxide, organic amine, potassium hydroxide, N-methylpyrrolidone, isopropyl alcohol and ethyl acetate, which shows solubility, is added to pure water or ultra pure water in the range of 0.01% to 50%. The reason is that the ion or the solvent dissolves a part of solid that exists on the interface between the foreign objects and the glass substrate 14 and adhesive force between the foreign objects and the glass substrate 14 can be weakened.

(Means)

In the above-described constitutions, by heating the liquid by the liquid heater 22 and spraying the heated liquid from the spray port 18a of the spray nozzle 18 after mixing it with the gas, liquid droplets whose temperature is controlled at 40° C. to 100° C. is blown onto the end surface 14b of the glass substrate 14 at high-speed. Thus, the end surface 14b of the glass substrate 14 is cleaned.

In other words, by controlling the temperature of the liquid droplets, which are sprayed from the spray port 18a of the spray nozzle 18 onto the end surface 14b of the glass substrate 14, at 40° C. to 100° C., it becomes possible to lift off foreign objects attached on the end surface 14b of the glass substrate 14 from the end surface 14b of the glass substrate 14, and high kinetic energy caused by the jet flow of the liquid droplets, which are sprayed from the spray port 18a of the spray nozzle 18 onto the end surface 14b of the glass substrate 14, can be instantaneously given to the foreign objects, so that the foreign objects attached on the end surface 14b of the glass substrate 14 after performing mechanical cut-off or polishing treatment can be effectively removed and the end surface 14b of the glass substrate 14 can be efficiently cleaned.

(Method)

Next, description will be made for the result of experiment that the present inventor conducted by using the substrate cleaning system 10. In this experiment, pure water, whose temperature was adjusted to 40° C. to 100° C. by using the liquid heater 22, was introduced from the liquid heater 22 to the spray nozzles 18 via the second liquid supply pipe 26 at the flow rate of about 0.5 L/min. At the same time, nitrogen was introduced from the gas supply source to the spray nozzles 18 via the gas supply pipe 20 at the flow rate of about 150 L/min, fluid where the pure water whose temperature was adjusted to 40° C. to 100° C. and nitrogen were mixed was created in the spray nozzles 18, the generated fluid is sprayed from the spray port 18a onto the end surface 14b of the glass substrate 14, and thus the foreign objects of 1 μm to 100 μm attached on the end surface 14b of the glass substrate 14 were removed.

Herein, in spraying the fluid from the spray port 18a of the spray nozzles 18, the angle of the spray nozzles 18 was adjusted to make the spray angle of fluid to the horizontal plane of the glass substrate 14 become 0 to 30 degrees.

Meanwhile, the temperature of the liquid was controlled by using the liquid heater 22 such that liquid temperature at the inflow port of the liquid became 40° C. to 100° C., more particularly. The speed of the glass substrate 14 moving on the roller conveyer 16 was 8 m/min, and time for substantially cleaning the end surface 14b of the glass substrate 14 was about 1 second.

It is to be noted that foreign object removing effect was evaluated by obtaining the amount of foreign objects, which were attached on the end surface 14b of the glass substrate 14, from a microscopic photograph, in this experiment.

(Effect)

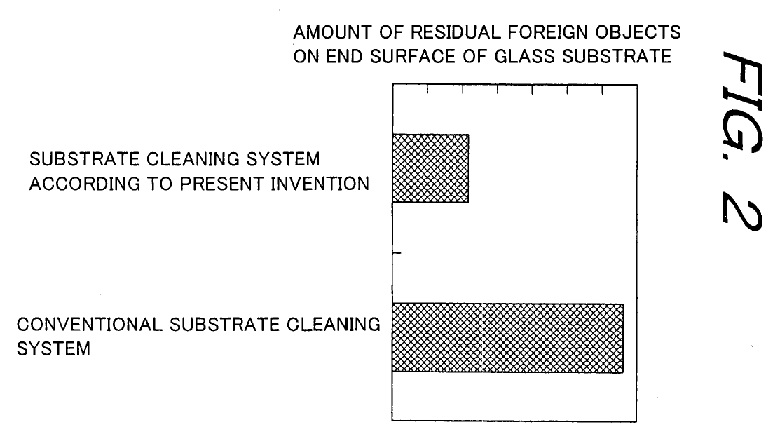

FIG. 2 shows the experiment result of foreign object removing effect, which was conducted on the above-described condition. More particularly, the graph comparatively shows the amount of residual foreign objects on the end surface 14b of the glass substrate 14 in the case where the end surface 14b of the glass substrate 14 was cleaned by the substrate cleaning system 10 according to the present invention after setting the temperature (liquid temperature) of pure water being the liquid to 60° C., and the amount of residual foreign objects on the end surface 14b of the glass substrate 14 in the case where the end surface 14b of the glass substrate 14 was cleaned by a conventional substrate cleaning system in which pure water being the liquid was not heated.

According to the experiment result shown in FIG. 2, the amount of foreign objects on the end surface 14b of the glass substrate 14 after cleaning was performed by the substrate cleaning system 10 according to the present invention was reduced to about ⅓ or less comparing to the amount of foreign objects on the end surface 14b of the glass substrate 14 after cleaning was performed by the conventional substrate cleaning system that does not include means for heating liquid, it was made clear that high cleaning effect was obtained by the substrate cleaning system 10 according to the present invention.

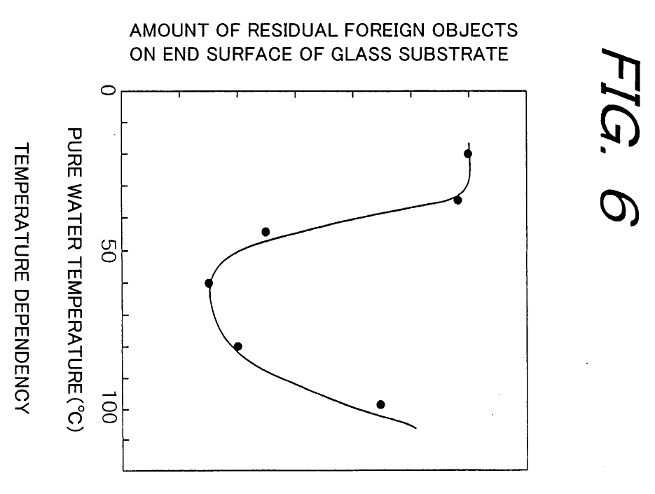

Further, experiment result became as shown in FIG. 6 when the temperature (liquid temperature) of pure water being the liquid was changed to 10° C. to 100° C., high cleaning effect was obtained similar to the experiment result shown in FIG. 2 even in the case where the temperature of pure water was set to 40° C. to 100° C., as compared with the conventional substrate cleaning system that does not include means for heating liquid. At this point, the temperature of substrate end surface increased to 40° C. to 100° C. by the collision of liquid droplets.

(Operation)

Meanwhile, the high cleaning effect by the substrate cleaning system 10 according to the present invention was remarkable in the case where the size of foreign objects was 1 μm to 100 μm, but remarkable foreign object removing effect by the heating of liquid was not observed in the case of 1 μm or less of foreign objects.

The inventor believes that the reason why the high cleaning effect is obtained by the substrate cleaning system 10 according to the present invention is caused by the large space between foreign objects having the size of 1 μm to 100 μm and the end surface 14b of a glass substrate 14 and by the lift-off of the foreign object from the end surface 14b of glass substrate 14 caused by volume expansion of air inside the space as shown in FIG. 7. Comparing to foreign objects of 1 μm or less, a larger volume space exists between the foreign objects having the size of 1 μm to 100 μm and the end surface 14b of glass substrate having the unevenness of about 0.1 μm to 500 μm, and it is believed that the large space promoted the lift-off effect. Generally, the volume expansion coefficient of air is 3.7×10⁻³K⁻¹ showing a value larger than that of solid by 2 digits or more, so that the promotion of lift-off effect by the increase of the space volume is remarkable.

On the other hand, no foreign object removing effect was observed when the glass substrate 14 was immersed in hot water of 60° C. In other words, foreign objects did not come off from the glass substrate 14 only by volume expansion of foreign objects, but they stayed on the end surface 14b of the glass substrate 14 as they were.

Therefore, the high cleaning effect by the substrate cleaning system 10 according to the present invention is synergy effect that is obtained by instantaneously generating both the kinetic energy given by liquid droplets and the volume expansion of air that exists between the foreign objects and the end surface 14b of the glass substrate 14 by the mixed flow of liquid and gas, which is ejected from spray nozzles 18, and it is a new method of removing foreign objects.

Meanwhile, in the case where the liquid temperature of pure water at the inflow port of liquid, which is provided for the spray nozzles 18, in the substrate cleaning system 10, is less than 40° C., cleaning effect having little difference from the cleaning effect obtained by the conventional substrate cleaning system, which uses pure water of normal temperature as the liquid, is only obtained, and the synergy effect by the increase of liquid temperature of pure water was not obtained.

This is believed to be because the volume expansion of the air that exists between the foreign objects and the end surface 14b of the glass substrate 14 was small when the temperature of pure water is less than 40° C., and lift-off effect did not occur.

Further, in the substrate cleaning system 10 according to the present invention, it is believed that as the liquid temperature of pure water at the inflow port of liquid, which is provided for the spray nozzles 18, approaches 100° C. being the boiling point, the particle diameter of liquid droplets becomes larger in spraying fluid where liquid and gas were mixed from the spray port 18a of the spray nozzles 18, and it is impossible to give kinetic energy evenly onto the end surface 14b of the glass substrate 14.

Further, as the temperature of liquid, relatively high cleaning power was shown when it was 45° C. to 90° C. in the range of 40° C. to 100° C. Furthermore, when even higher cleaning power is required, it is preferable to control the temperature of liquid flown to the inflow port of liquid, which is provided for the spray nozzles 18, to be 50° C. to 80° C.

### SUPPLEMENTAL EXAMPLE 1

Further, when pure water, to which a substance such as hydrofluoric acid, phosphoric acid, acetic acid, oxalic acid, ammonium fluoride, potassium fluoride, sodium fluoride, calcium fluoride and triethyl phosphate, which generates fluoride ion, phosphate ion or organic calboxylic acid ion, or a substance showing solubility such as tetramethylammonium hydroxide, organic amine, potassium hydroxide, N-methylpyrrolidone, isopropyl alcohol and ethyl acetate, was added in the range of 0.01% to 50%, was used as the liquid, relatively high cleaning capability was obtained comparing to the case of single pure water.

The reason is believed that the adhesive force between the foreign objects and the glass substrate 14 can be weakened by dissolving a part of solid, which exists on the interface between the foreign objects and the glass substrate 14, by ion and solvent. In this case as well, as the temperature of liquid, particularly high cleaning power was shown when it was 45° C. to 90° C. in the range of 40° C. to 100° C. Furthermore, even higher cleaning power was shown when the temperature of liquid flown to the inflow port of liquid, which was provided for the spray nozzles 18, was controlled to 50° C. to 80° C.

### SUPPLEMENTAL EXAMPLE 2

Further, in the substrate cleaning system 10 according to the present invention, due to the reason that the end surface 14b of the glass substrate 14 can be cleaned by the cleaning time of as short as 1 second, high cleaning capability is obtained by a simple constitution that the spray nozzles 18 are installed between spindles of the roller conveyer 16, its practical value is very high.

Specifically, in the substrate cleaning system 10 according to the present invention, due to the reason that the end surface 14b of the glass substrate 14 can be cleaned by the cleaning time of as short as 1 second, it is possible to clean the both end surfaces 14b of the glass substrate 14 while the glass substrate 14 is transported by the roller conveyer 16.

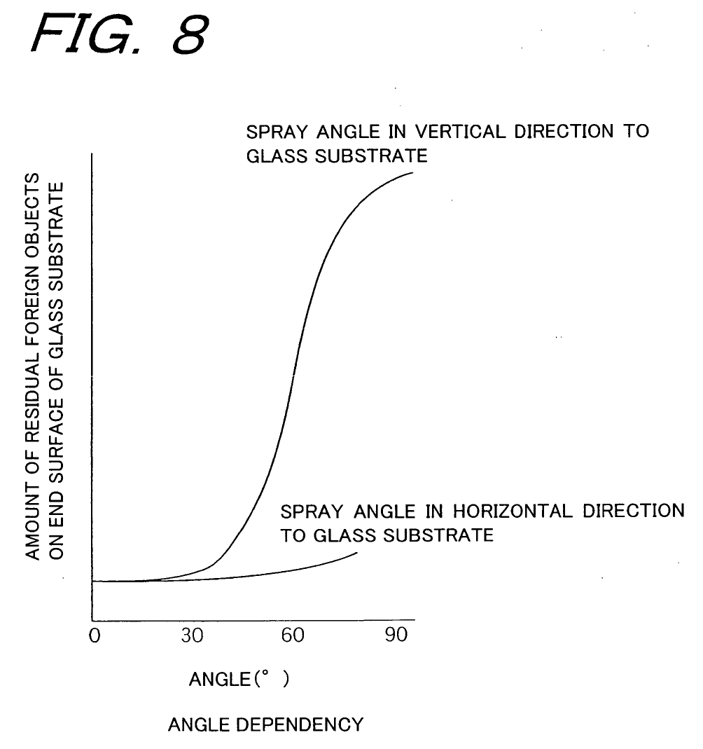

Further, FIG. 8 shows the result of experiment in which the installing angle of the spray nozzles 18 is changed. The installing position of the spray nozzles 18 is acceptable when the spray angle of fluid is within the range of 0° to 30° in the vertical directions to the substrate, and the position is not limited in horizontal directions as long as it is within the range where the spray nozzles 18 and the glass substrate 14 do not contact. The reason is believed that a shape of unevenness that exists on the end surface 14b of the glass substrate 14 has anisotropy, and when the angle is changed in vertical directions, the convex portions become barriers prevent liquid droplets from colliding the foreign objects. In other words, this shows that the same effect is obtained when the angle of the spray nozzles 18 is freely operated while the glass substrate 14 is cleaned or substrate cleaning is performed by arranging a plurality of spray nozzles 18 having different installing angles, within the above-described range.

It is to be noted that the angle in the vertical directions indicates an angle formed by the centerline of the spray nozzles 18 and the surface of the glass substrate 14. Further, the angle in the horizontal directions is an angle that the center line of the spray nozzle 18 forms with respect to a straight line that is within the same plane as the surface of the glass substrate 14 and orthogonal to a straight line forming the end surface 14b of the glass substrate 14.

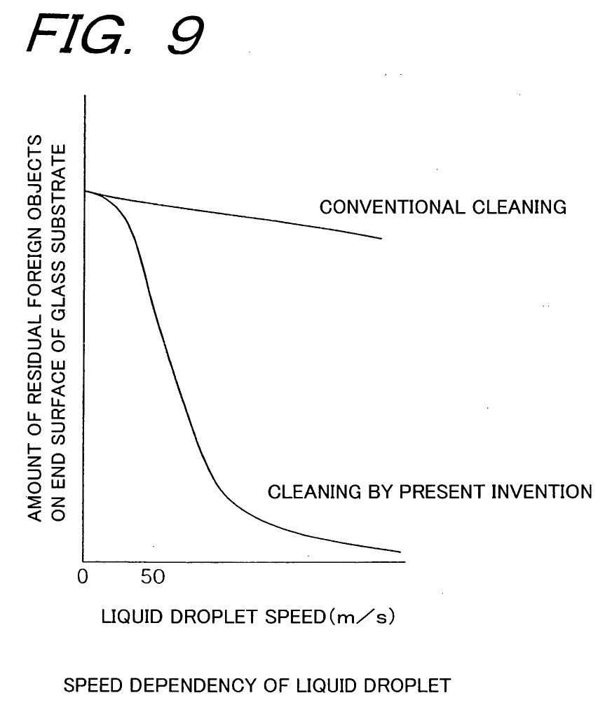

Further, FIG. 9 shows the experiment result when the spray speed of liquid droplets is changed. To obtain the effect by the present invention, the spray speed of 50 m/s or higher is required. In other words, the drawing shows that the effect of the present invention is obtained by setting a distance between the glass substrate 14 and the spray port 18a of the spray nozzles 18 and the flow rate/pressure of pure water and gas to arbitrary values to obtain the flow speed of 50 m/s or higher. Meanwhile, when a spray distance is changed to 1 mm to 100 mm in the cleaning method according to the present invention, it was possible to obtain the flow speed of 50 m/s or higher under any condition, and the high cleaning effect by the present invention was obtained.

### SUPPLEMENTARY EXAMPLE 3

It is to be noted that, in the substrate cleaning system 10 shown in FIG. 1, a front end surface 14c and a rear end surface in the transporting direction of the glass substrate 14, which is transported in the vertical direction to the page surface of FIG. 1, cannot be cleaned because the spray nozzles 18 are not installed.

To clean the front end surface 14c and the rear end surface in the transporting direction of the glass substrate 14, the spray nozzles 18 should be disposed freely movable around the roller conveyer 16 in arranging the spray nozzles 18, for example.

By installing the spray nozzles 18 as described above, in cleaning the end surface 14b, the front end surface 14c and the rear end surface of the glass substrate 14, the movement of the glass substrate 14 should be temporarily stopped on the roller conveyer 16 transporting the glass substrate 14, and liquid droplets should be sprayed from the spray port 18a to the substrate 14 while the spray nozzles 18 are moved so as to go around the roller conveyer 16 after the movement is stopped. This makes it possible to spray liquid droplets onto the end surface 14b, the front end surface 14c and the rear end surface of the glass substrate 14 and to clean all end surfaces of the glass substrate 14.

Further, the following method may be employed in order to clean the front end surface 14c and the rear end surface in the transporting direction of the glass substrate 14.

Specifically, by processing the tip shape of the spray port 18a of the spray nozzles 18 into a rectangular shape or an elliptic shape, a mixed flow in which the aspect ratio of the shape is deformed into 2:1 to 50:1 is obtained as a mixed flow of liquid and gas sprayed from the spray port 18a. Herein, 2 to 20 of the spray nozzles 18, where the tip shape of the spray port 18a is processed into the rectangular shape or the elliptic shape, are arranged so as to surround the glass substrate 14 mounted on the roller conveyer 16. At this point, each spray nozzle 18 is arranged such that the long side of the mixed flow sprayed from the spray port 18a goes along the plane direction of the glass substrate 14 and the mixed flow sprayed from each spray nozzle 18 covers the end surface 14b, the front end surface 14c and the rear end surface of the glass substrate 14, which are all end surfaces of the substrate. Consequently, the mixed flow can be sprayed onto the end surface 14b, the front end surface 14c and the rear end surface of the glass substrate 14, which are all end surfaces of the substrate, at once in the state where the spray nozzles 18 are fixed. In short, by stopping the glass substrate 14 mounted on the roller conveyer 16 for a few seconds on the roller conveyer 16 and spraying the mixed flow from the spray nozzles 18 while the substrate is stopped, it becomes possible to clean the end surface 14b, the front end surface 14c and the rear end surface of the glass substrate 14, which are all end surfaces of the substrate, at once.

### SUPPLEMENTARY EXAMPLE 4

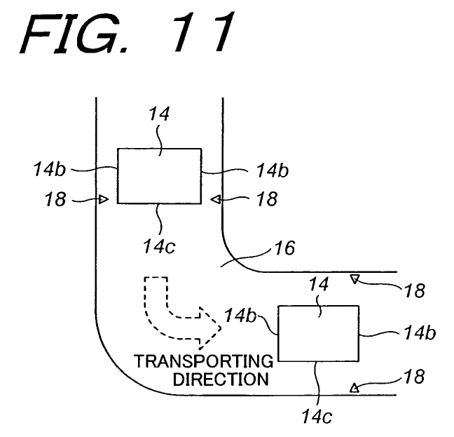

Furthermore, the following method may be employed in order to clean the front end surface 14c and the rear end surface in the transporting direction of the glass substrate 14. As shown in FIG. 11, the transporting route of the cleaning system is formed into an L-shape, spray nozzles are severally disposed on the front and rear of an L-shaped curve, the end surface 14b of the glass substrate 14 may be cleaned before the curve and the front end surface 14c of the glass substrate may be cleaned after the curve.

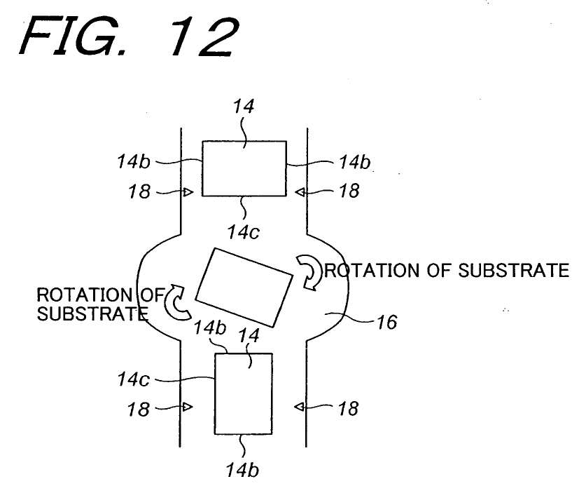

Further, the following method may be employed in order to clean the front end surface 14c and the rear end surface in the transporting direction of the glass substrate 14. As shown in FIG. 12, a mechanism for rotating the glass substrate by 90 degrees is provided in the middle of the transporting route of the cleaning system, spray nozzles are severally disposed on the front and rear of the rotation mechanism, the end surface 14b of the glass substrate 14 may be cleaned before the rotation mechanism and the front end surface 14c and the rear end surface of the glass substrate may be cleaned after the rotation mechanism. Furthermore, spray nozzles may be disposed in the rotation mechanism area.

The above-described method of cleaning the end surface 14b, the front end surface 14c and the rear end surface of the glass substrate 14 is particularly effective for the glass substrate 14 having the thickness of 5 mm or less and the size of 900 mm (width)×700 mm (length) or larger.

(Supplementary Constitution)

Further, it is necessary for a method of obtaining the effect of the present invention to include means for spraying liquid droplets having the flow speed of 50 m/s or higher and means for heating a substrate to the temperature of 40° C. or higher. In the means for heating the glass substrate 14, the lift-off effect in the present invention can be obtained by using a heating method by a halogen, UV or IR lamp heater or a heating method by blowing hot air with a fan in which the above-described lamp heater or heating wire is built. It is to be noted that the temperature of liquid droplets sprayed by the liquid droplets spray means is not particularly limited when the glass substrate 14 is heated by the above-described heating means, and it is possible to blow away the foreign objects separated from the glass substrate 14 by the lift-off effect if the flow speed is 50 m/s or higher.

### EXAMPLE 2

(Constitution and Means)

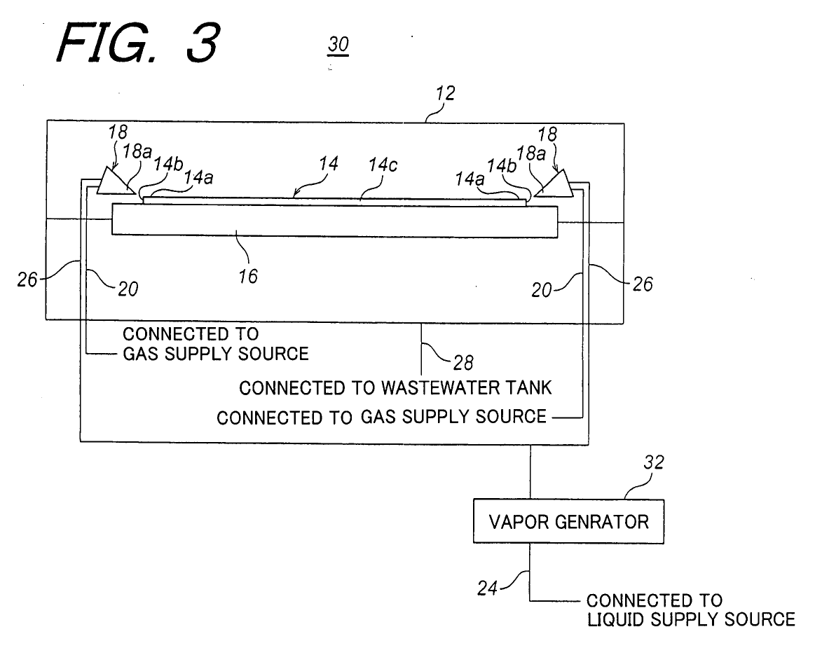

Next, FIG. 3 shows the schematic constitution explanatory view of the substrate cleaning system according to the second embodiment of the present invention. In the following explanation of the substrate cleaning system according to the second embodiment of the present invention, the same reference numerals as FIG. 1 are applied to the same or corresponding constitution as the substrate cleaning system according to the first embodiment of the present invention, which is shown in FIG. 1, and explanation of their detail constitution and operation are appropriately omitted.

The substrate cleaning system 30 according to the second embodiment of the present invention is different from the substrate cleaning system 10 according to the first embodiment of the present invention shown in FIG. 1 only on the point where the system 30 includes a vapor generator 32 instead of the liquid heater 22.

Herein, the vapor generator 32 includes a liquid storage tank that stores liquid supplied from the liquid supply source, a steamer that generates vapor by heating and evaporating the liquid stored in the liquid storage tank, a supply pump for supplying the liquid from the liquid storage tank to the steamer, a flow meter that measures the flow rate of the liquid to be supplied from the liquid storage tank to the steamer, a pressure meter that measures vapor pressure generated from the steamer, a filter that removes foreign objects in the liquid to be supplied from the liquid storage tank to the steamer, a pump for supplying the vapor generated by the steamer to the spray nozzles 18 via the second liquid supply pipe 26, and the like. It is to be noted that the steamer is a heater having about 3 kW, for example, and it can generate steam containing liquid droplets of 40° C. to 100° C. from the spray nozzles 18 by adjusting the output of the heater.

(Method)

Herein, description will be made for the result of experiment that the present inventor conducted by using the substrate cleaning system 30. In this experiment, the vapor of pure water generated by the vapor generator 32 was introduced from the vapor generator 32 to the spray nozzles 18 via the second liquid supply pipe 26 at the flow rate of about 0.13 L/min, the mixed flow of the vapor created in the spray nozzles 18 and liquid that consist of the same component was sprayed from the spray port 18a onto the end surface 14b of the glass substrate 14, the foreign objects of 1 μm to 100 μm attached on the end surface 14b of the glass substrate 14 were removed by the liquid droplets sprayed at high speed.

Herein, in spraying the mixed flow of the vapor and the liquid that consist of the same component from the spray port 18a of the spray nozzles 18, the angle of the spray nozzles 18 was adjusted such that the spray angle of the mixed flow became 0 to 30 degrees to the horizontal plane of the glass substrate 14, and the mixed flow was sprayed onto the end surface 14b of the glass substrate 14 such that the impact pressure of 0.2 MPa to 0.5 MPa was applied to the end surface 14b of the glass substrate 14.

It is to be noted that the foreign object removing effect was evaluated by obtaining the amount of foreign objects, which were attached on the end surface 14b of the glass substrate 14, from a microscopic photograph, in this experiment.

(Effect)

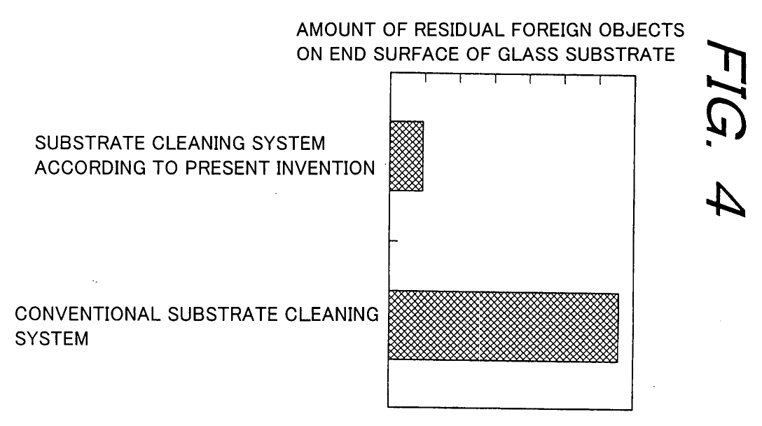

FIG. 4 shows the experiment result of foreign object removing effect, which was conducted based on the above-described condition. More specifically, the graph comparatively shows the amount of residual foreign objects on the end surface 14b of the glass substrate 14 in the case where the temperature (vapor temperature) of the mixed flow of the vapor of pure water and the liquid that consists of the same component was set to 60° C. and the end surface 14b of the glass substrate 14 was cleaned by using the substrate cleaning system 30 according to the present invention, and the amount of residual foreign objects on the end surface 14b of the glass substrate 14 in the case where the end surface 14b of the glass substrate 14 was cleaned by the conventional substrate cleaning system where pure water being the liquid was not heated.

According to the experiment result shown in FIG. 4, the amount of foreign objects after cleaning by the substrate cleaning system 30 according to the present invention was reduced to about ⅕ or less when compared with the amount of foreign objects on the end surface 14b of the glass substrate 14 after cleaning by the conventional substrate cleaning system that does not include the means for heating liquid, and it was made clear that high cleaning effect was obtained by the substrate cleaning system 30 according to the present invention. Further, in the substrate cleaning system 30 according to the present invention, particularly high cleaning effect was obtained when the temperature of the mixed flow was 40° C. to 100° C. At this point, the temperature on the substrate end surface increased to 40° C. to 100° C. due to the collision of liquid droplets.

(Operation)

It is to be noted that the high cleaning effect by the substrate cleaning system 30 according to the present invention was remarkable when the size of foreign objects was 1 μm to 100 μm similar to the case of the substrate cleaning system 10 according to the present invention, but the remarkable foreign object removing effect by the heating of liquid was not observed in the case of foreign objects having the size of 1 μm or less.

The reason why the high cleaning effect by the substrate cleaning system 30 according to the present invention is believed to be because of the synergy effect of both the lift-off effect of foreign objects from the end surface 14b of the glass substrate 14, which is caused by the volume expansion of air in a space that exists between the foreign objects having the size of 1 μm to 100 μm and the end surface 14b of the glass substrate 14 because the space is large, and the kinetic energy by the impact pressure of 0.2 MPa to 0.5 MPa that can be given to the foreign objects instantaneously.

Moreover, according to the substrate cleaning system 30 of the present invention, higher cleaning effect than that of the substrate cleaning system 10 by Example 1 was obtained. Its reason is believed to be because liquid droplets having small average particle diameter could be uniformly formed due to the use of the vapor generator 32, uniform kinetic energy could be given to the end surface 14b of the glass substrate 14 and vapor sprayed from the spray nozzles into the atmosphere was condensed and liquid droplets whose temperature was increased could be formed to promote the lift-off effect.

### SUPPLEMENTAL EXAMPLE 1

Furthermore, when vapor of pure water, to which a substance such as hydrofluoric acid, phosphoric acid, acetic acid, oxalic acid, ammonium fluoride, potassium fluoride, sodium fluoride, calcium fluoride and triethyl phosphate, which generates fluoride ion, phosphate ion or organic calboxylic acid ion, or a substance showing solubility such as tetramethylammonium hydroxide, organic amine, potassium hydroxide, N-methylpyrrolidone, isopropyl alcohol and ethyl acetate, was added in the range of 0.01% to 50%, was used as the vapor, relatively high cleaning capability was obtained comparing to the case of single pure water.

This is believed to be because the adhesive force between the foreign object and the glass substrate 14 can be weakened by dissolving a part of solid, which exists on the interface between the foreign objects and the glass substrate 14, by ion and solvent.

### EXAMPLE 3

(Constitution and Means)

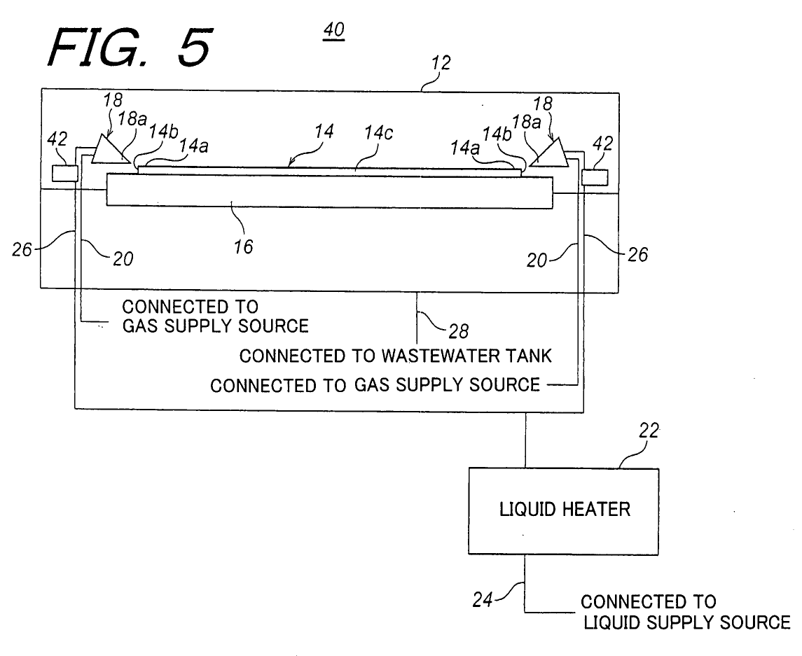

Next, FIG. 5 shows the schematic constitution explanatory view of the substrate cleaning system according to the third embodiment of the present invention. In the following explanation of the substrate cleaning system according to the third embodiment of the present invention, the same reference numerals as FIG. 1 are applied to the same or corresponding constitution as the substrate cleaning system according to the first embodiment of the present invention, which is shown in FIG. 1, and explanation of their detail constitution and operation are appropriately omitted.

The substrate cleaning system 40 according to the third embodiment of the present invention is different from the substrate cleaning system 10 according to the first embodiment of the present invention shown in FIG. 1 only on the point where the system 40 includes second liquid heaters 42 adjacent to the spray nozzles 18 in the middle of the route of the second liquid supply pipe 26.

In the substrate cleaning system 40, liquid is heated by the liquid heater 22 and the heated liquid is supplied to the spray nozzles 18 via the second liquid supply pipe 26. The liquid to be supplied to the spray nozzles 18 via the second liquid supply pipe 26 is supplied to the spray nozzles 18 after it is re-heated by the second liquid heaters 42 arranged adjacent to the spray nozzles 18. By spraying the re-heated liquid from the spray nozzles 18 after mixing it with gas, liquid droplets whose temperature was adjusted to 40° C. to 100° C. is blown onto the end surface 14b of the glass substrate 14 at high speed. Thus, the end surface 14b of the glass substrate 14 is cleaned.

As described, according to the substrate cleaning system 40, the liquid having passed through the second liquid supply pipe 26 can be re-heated by the second liquid heaters 42, so that it is possible to compensate liquid temperature reduction caused by passing of the liquid through the second liquid supply pipe 26 and to maintain the temperature of the liquid at a desired temperature.

(Method and Effect)

Next, description will be made for the result of experiment that the present inventor conducted by using the substrate cleaning system 40. In this experiment, pure water was introduced from the liquid heater 22 to the spray nozzles 18 via the second liquid supply pipe 26 and the second liquid heaters 42 at the flow rate of about 0.5 L/min. At the same time, nitrogen was introduced from the gas supply source to the spray nozzles 18 via the gas supply pipe 20 at the flow rate of about 150 L/min, fluid where pure water and nitrogen were mixed was created in the spray nozzles 18, the created fluid was sprayed from the spray port 18a onto the end surface 14b of the glass substrate 14, and thus the foreign objects of 1 μm to 100 μm attached on the end surface 14b of the glass substrate 14 were removed.

Herein, in spraying the fluid from the spray port 18a of the spray nozzles 18, the angle of the spray nozzles 18 was adjusted to make the spray angle of fluid to the horizontal plane of the glass substrate 14 become 0 to 30 degrees.

Further, the temperature of the liquid was controlled by using the liquid heater 22 and the second liquid heaters 42 such that the liquid temperature at the inflow port of liquid became 40° C. to 100° C.

According to the experiment result obtained by the present inventor, the amount of foreign objects after cleaning by the substrate cleaning system 40 according to the present invention was reduced to about ⅓ or less when compared with the amount of foreign objects on the end surface 14b of the glass substrate 14 after cleaning by the conventional substrate cleaning system that does not include the means for heating liquid, and it was made clear that high cleaning effect was obtained by the substrate cleaning system 40 according to the present invention. Further, in the substrate cleaning system 40 according to the present invention, particularly high cleaning effect was obtained when the temperature of pure water was 40° C. to 100° C. At this point, the temperature on the substrate end surface increased to 40° C. to 100° C. due to the collision of liquid droplets.

(Operation)

Meanwhile, the high cleaning effect by the substrate cleaning system 40 according to the present invention was remarkable in the case where the size of foreign objects was 1 μm to 100 μm similar to the case of the substrate cleaning system 10 according to the present invention, but remarkable foreign object removing effect was not observed in the case of 1 μm or less of foreign objects.

The inventor believes that the reason why the high cleaning effect is obtained by the substrate cleaning system 40 according to the present invention is that the space between the foreign objects having the size of 1 μm to 100 μm and the end surface 14b of the glass substrate 14 was large and it caused the lift-off effect of the foreign objects from the end surface 14b of glass substrate 14 caused by volume expansion of air inside the space.

Further, in the substrate cleaning system 40 according to the present invention, more stable high cleaning effect could be obtained without suffering from external factors such as air temperature.

[Supplemental Explanation of Constitution]

Meanwhile, the embodiments described above may be modified as explained in (1) to (7) below.

(1) In the above-described embodiments, a temperature sensor was not particularly provided for the spray nozzles 18, but it goes without saying that the invention is not limited to this. For example, a liquid temperature sensor may be installed to an area of the second liquid supply pipe 26 for supplying liquid to the spray nozzles 18, which is adjacent to the spray nozzles 18, and electric power supplied to the heater is adjusted by controlling the electric power control mechanism of the liquid heater 22 in response to temperature detected by the liquid temperature sensor, and the temperature of the liquid immediately before supplied to the spray nozzles 18 may be freely set in the range of 20° C. to 100° C.

(2) The above-described embodiments showed the substrate cleaning system 10 including the liquid heater 22 as a single liquid heating means in the route for introducing liquid to the spray nozzles 18, which is the first embodiment of the present invention, and the substrate cleaning system 30 including the liquid heater 22 and the second liquid heaters 42 as a plurality of liquid heating means in the route for introducing liquid to the spray nozzles 18, which is the second embodiment of the present invention. However, the installing number of the liquid heating means is not to the above-described ones, but an appropriate number of the heating means may be installed corresponding to the length or the like of the route for introducing the liquid to the spray nozzles 18. When installing a plurality of liquid heating means, it is preferable to constitute them by installing at least near the spray nozzles 18 to compensate liquid temperature reduction caused by passing of the liquid through the route for introducing liquid to the spray nozzles 18 and to maintain the temperature of the liquid at a desired temperature.

Further, in setting a single or a plurality of liquid heating means in the route for introducing the liquid to the spray nozzles 18, they may be arranged only near the spray nozzles 18. Specifically, in the substrate cleaning system 30 being the second embodiment of the present invention, the liquid heater 22 may be removed and only the second liquid heaters 42 may be disposed.

(3) In the above-described embodiments, a check valve for preventing the reverse flow of liquid from the steamer to the liquid storage tank was not particularly provided for the vapor generator 32. However, it goes without saying that the invention is not limited to this, but the check valve may be provided to prevent the reverse flow of liquid from the steamer to the liquid storage tank.

(4) In the above-described embodiments, the vapor generator 32 supplied liquid from the liquid storage tank to the steamer by the supply pump. However, it goes without saying that the invention is not limited to this, but pressurized nitrogen may be supplied to the liquid storage tank without using the supply pump and the liquid may be pushed into the steamer by pressure, for example.

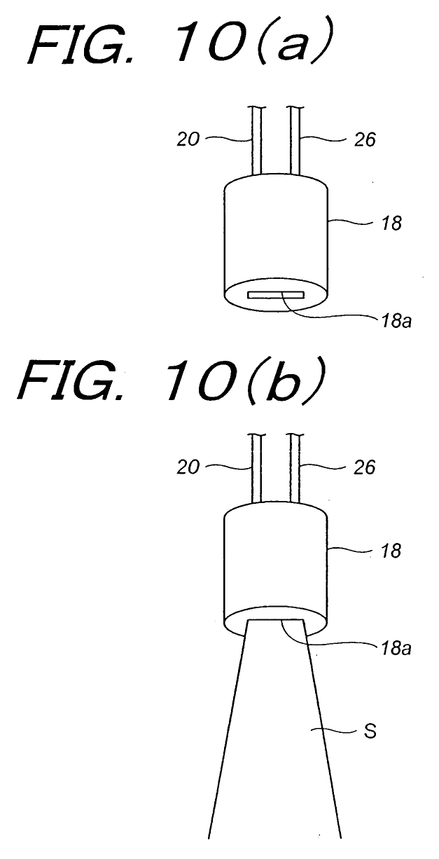

(5) In the above-described embodiments, detailed explanation was omitted for the shape of the spray port 18a of the spray nozzles 18, but the spray port 18a of the spray nozzles 18 may be formed into the linear shape as shown in FIG. 10A, that is, a slit-shaped rectangular shape. When the spray port 18a having the linear shape as shown in FIG. 10A, that is, the slit-shaped rectangular shape is used as the spray nozzles 18 of the substrate cleaning system 30 being the second embodiment of the present invention, the spray pattern S of vapor widens in a wide angle as shown in FIG. 10B, and it becomes possible to clean a wide area at once.

(6) In the above-described embodiments, detailed explanation was omitted for the vapor sprayed from the spray port 18a of the spray nozzles 18, but cleaning can be performed efficiently if vapor of liquid having the boiling point of 40° C. or higher is used.

(7) The above-described embodiments and the above-described modifications shown in (1) to (6) may be appropriately combined.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosure of Japanese Patent Application No. 2006-144690 filed on May 24, 2006 including specification, claims, drawings and summary are incorporated herein by reference in its entirety.

What is claimed is:

1. A substrate cleaning system that cleans a glass substrate by supplying liquid and gas to spray nozzles and by spraying fluid, where said liquid and said gas are mixed in said spray nozzles, onto the end surface of said substrate, said system comprising:
liquid heating means for heating the liquid to be supplied to the spray nozzles to control the temperature of said liquid, wherein
the temperature of said liquid at the inlet of said spray nozzles is controlled at 40° C. to 100° C.

2. The substrate cleaning system according to claim 1, wherein
said liquid heating means is disposed in an area of a route for introducing said liquid to said spray nozzles, which is near said spray nozzles.

3. A substrate cleaning system that cleans a substrate by fluid sprayed from spray nozzles, said system comprising:
spray nozzles disposed near the substrate; and
vapor generating means for generating vapor and supplying the vapor to said spray nozzles, wherein
said spray nozzles spray the vapor supplied from said vapor generating means onto the substrate.

4. The substrate cleaning system according to claim 1, wherein
the shape of spray port of said spray nozzles, which sprays vapor, is in a linear shape.

5. The substrate cleaning system according to claim 2, wherein
the shape of spray port of said spray nozzles, which sprays vapor, is in a linear shape.

6. The substrate cleaning system according to claim 3, wherein
the shape of spray port of said spray nozzles, which sprays vapor, is in a linear shape.

7. The substrate cleaning system according to claim 3, wherein
vapor sprayed from said spray nozzles is the vapor of liquid having the boiling point of 40° C. or higher.

8. The substrate cleaning system according to claim 4, wherein
vapor sprayed from said spray nozzles is the vapor of liquid having the boiling point of 40° C. or higher.

9. The substrate cleaning system according to claim 5, wherein
vapor sprayed from said spray nozzles is the vapor of liquid having the boiling point of 40° C. or higher.

10. The substrate cleaning system according to claim 6, wherein
vapor sprayed from said spray nozzles is the vapor of liquid having the boiling point of 40° C. or higher.

11. A substrate cleaning method that cleans a substrate by supplying liquid and gas to spray nozzles and by spraying fluid, where said liquid and said gas are mixed in said spray nozzles, onto said substrate, wherein
the liquid to be supplied to the spray nozzles is heated and the temperature of said liquid is controlled to 40° C. to 100° C.

12. A substrate cleaning method that cleans a substrate by fluid sprayed from spray nozzles, wherein
vapor is supplied to the spray nozzles, and the vapor supplied from said spray nozzles is sprayed onto the substrate.

13. The substrate cleaning system according to claim 3, wherein
the vapor sprayed from said spray nozzles is steam that consists of any of water, pure water and ultra pure water.

14. The substrate cleaning system according to claim 4, wherein
the vapor sprayed from said spray nozzles is steam that consists of any of water, pure water and ultra pure water.

15. The substrate cleaning system according to claim 5, wherein
the vapor sprayed from said spray nozzles is steam that consists of any of water, pure water and ultra pure water.

16. The substrate cleaning system according to claim 6, wherein
the vapor sprayed from said spray nozzles is steam that consists of any of water, pure water and ultra pure water.

17. The substrate cleaning system according to claim 1, wherein
the temperature of the end surface of a substrate is increased to 40° C. to 100° C. by the fluid sprayed from said spray nozzles.

18. The substrate cleaning system according to claim 2, wherein
the temperature of the end surface of a substrate is increased to 40° C. to 100° C. by the fluid sprayed from said spray nozzles.

19. The substrate cleaning system according to claim 3, wherein
the temperature of the end surface of a substrate is increased to 40° C. to 100° C. by the fluid sprayed from said spray nozzles.
